(19) United States
(12) Patent Application Publication
(10) Pub. No.: US 2025/0125084 A1
(43) Pub. Date: Apr. 17, 2025

(54) COUPLED INDUCTOR AND THE METHOD TO MAKE THE SAME

(71) Applicant: CYNTEC CO., LTD., HSINCHU (TW)

(72) Inventors: SEN-HUEI CHEN, HSINCHU (TW); Chi Shiuan Shie, HSINCHU (TW); I-AN CHEN, HSINCHU (TW)

(21) Appl. No.: 18/918,160

(22) Filed: Oct. 17, 2024

Related U.S. Application Data
(60) Provisional application No. 63/544,450, filed on Oct. 17, 2023.
(60) Provisional application No. 63/649,331, filed on May 18, 2024.

(51) Int. Cl. H01F 27/29; H01F 27/02; H01F 27/24; H01F 27/32

(52) U.S. Cl. CPC H01F 27/29; H01F 27/022; H01F 27/24; H01F 27/327

(57) ABSTRACT

A coupled inductor, comprising: a first conductive body, comprising a first lateral portion, a first top portion, and a second lateral portion, wherein the first conductive body extends from the first lateral portion to the second lateral portion via the first top portion; a second conductive body, comprising a third lateral portion, a second top portion, and a fourth lateral portion, wherein the second conductive body extends from the third lateral portion to the fourth lateral portion via the second top portion; and a molding body, encapsulating the first lateral portion, the first top portion, and the second lateral portion of the first conductive body.

### CROSS-REFERENCES TO RELATED APPLICATIONS

This application claims the benefit of U.S. Provisional Patent Application No. 63/544,450 filed on Oct. 17, 2023, each of which is hereby incorporated by reference herein and made a part of the specification.

### BACKGROUND OF THE INVENTION

### I. Field of the Invention

The present invention relates to a coupled inductor, and in particular to, an inverse-coupling coupled inductor.

### II. Description of Related Art

A conventional coupled inductor has two laterally-placed pillars, wherein a coil is wound on each of the two laterally-placed pillars. Such a design sacrifices the volume of the magnetic material to achieve the desired coefficient value. As a result, it is not suitable for a design that requires a smaller size.

Therefore, a better solution is needed to resolve the issues mentioned above.

### SUMMARY OF THE INVENTION

The present invention discloses a coupled inductor, wherein the coupled inductor comprises: a first conductive body, comprising a first lateral portion, a first top portion, and a second lateral portion, wherein the first conductive body extends from the first lateral portion to the second lateral portion via the first top portion, wherein the first conductive body further comprises a first terminal portion that is bent from the first lateral portion and extends in a direction away from the second lateral portion and a second terminal portion that is bent from the second lateral portion and extends in a direction away from the first lateral portion; a second conductive body, comprising a third lateral portion, a second top portion, and a fourth lateral portion, wherein the second conductive body extends from the third lateral portion to the fourth lateral portion via the second top portion, wherein the second conductive body further comprises a third terminal portion that is bent from the third lateral portion and extends in a direction towards the fourth lateral portion and a fourth terminal portion that is bent from the fourth lateral portion and extends in a direction towards the third lateral portion; and a molding body, encapsulating the first lateral portion, the first top portion, and the second lateral portion of the first conductive body.

In one embodiment, on a horizontal plane passing through the first lateral portion and the third lateral portion, a cross-section surface area of the first lateral portion is larger than a cross-section surface area of the third lateral portion.

In one embodiment, a magnetic core is disposed in a hollow space of the second conductive body.

In one embodiment, a molding body encapsulates the first conductive body, the second conductive body and the magnetic core.

In one embodiment, a material is filled in a space between the first terminal portion and the third terminal portion.

In one embodiment, the material is a magnetic material.

In one embodiment, the material is a polymer, an oxide or a ceramic material.

In one embodiment, the first conductive body is fully encapsulated by a first insulating layer, and the second conductive body is fully encapsulated by a second insulating layer, wherein the first insulating layer is attached to the second insulating layer by an adhesive material.

In one embodiment, a bottom surface of the first terminal portion is not covered by the first insulating layer to expose a first inner metal portion for forming a first electrode of the first conductive body.

In one embodiment, a bottom surface of the second terminal portion is not covered by the first insulating layer to expose a second inner metal portion for forming a second electrode of the first conductive body.

In one embodiment, a bottom surface of the third terminal portion is not covered by the second insulating layer to expose a third inner metal portion for forming a third electrode of the second conductive body.

In one embodiment, a bottom surface of the fourth terminal portion is not covered by the second insulating layer to expose a fourth inner metal portion for forming a fourth electrode of the second conductive body.

In one embodiment, the width of the first conductive body is equal to the width of the second conductive body.

In one embodiment, the curvature radius of the inner surface of the first bending portion of the first conductive body is greater than or equal to the curvature radius of the outer surface of the first bending portion of the second conductive body.

In one embodiment, the curvature radius of the inner surface of the second bending portion of the first conductive body is greater than or equal to the curvature radius of the outer surface of the second bending portion of the second conductive body.

The present invention discloses a coupled inductor, wherein the coupled inductor comprises: a first conductive body, comprising a first lateral portion, a first top portion, and a second lateral portion, wherein the first conductive body extends from the first lateral portion to the second lateral portion via the first top portion, wherein the first conductive body further comprises a first terminal portion that is bent from the first lateral portion and extends in a direction away from the second lateral portion; and a second conductive body, comprising a third lateral portion, a second top portion, and a fourth lateral portion, wherein the second conductive body extends from the third lateral portion to the fourth lateral portion via the second top portion, wherein the second conductive body further comprises a second terminal portion that is bent from the third lateral portion and extends in a direction towards the fourth lateral portion; and wherein a material is filled in a space between the first terminal portion and the second terminal portion.

In one embodiment, the material is a magnetic material.

The present invention discloses a coupled inductor, wherein the coupled inductor comprises: a first conductive body, comprising a first lateral portion, a first top portion, and a second lateral portion, wherein the first conductive body extends from the first lateral portion to the second lateral portion via the first top portion, wherein the first conductive body is fully encapsulated by a first insulating layer; and a second conductive body, comprising a third lateral portion, a second top portion, and a fourth lateral portion, wherein the second conductive body extends from the third lateral portion to the fourth lateral portion via the second top portion, wherein the second conductive body is fully encapsulated by a second insulating layer; wherein the first insulating layer is attached to the second insulating layer by an adhesive material.

The present invention discloses a coupled inductor, wherein the coupled inductor comprises: a first conductive body, comprises a first terminal portion, wherein the first conductive body is encapsulated by a first insulating layer, wherein a bottom surface of the first terminal portion is not covered by the first insulating layer to expose an inner metal portion; and a molding body, encapsulating the first conductive body, wherein an electrode structure is disposed on the inner metal portion and electrically connected to the first conductive body, wherein a first top portion of the electrode structure is located on a first lateral side of the inner metal portion, wherein the first top portion of the electrode structure is attached to the molding body through a first silver-glue layer.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention, the drawings are briefly described as follows.

FIG. 1 shows a view of a coupled inductor according to one embodiment of the present invention.

FIG. 2 shows a view of a coupled inductor according to one embodiment of the present invention.

FIG. 3 shows a view of a coupled inductor according to one embodiment of the present invention.

FIG. 4 shows a view of a coupled inductor according to one embodiment of the present invention.

FIG. 5 shows a view of an electrode structure of a coupled inductor according to one embodiment of the present invention.

FIG. 6 shows a view an electrode structure of a coupled inductor according to one embodiment of the present invention.

FIG. 7 shows a view of an electrode structure of a coupled inductor according to one embodiment of the present invention.

FIG. 8 shows a view of an electrode structure of a coupled inductor according to one embodiment of the present invention.

FIG. 9 shows a view of the side surfaces of terminal portions of a second conductive body of a coupled inductor according to one embodiment of the present invention.

FIG. 10 shows a view of the side surfaces of terminal portions of a second conductive body of a coupled inductor according to one embodiment of the present invention.

FIG. 11 shows a view of a material filled in a space between the terminal portion of the first conductive body of the coupled inductor and the terminal portion of the second conductive body of the coupled inductor according to one embodiment of the present invention.

FIG. 12 shows a view of a material filled in a space between the terminal portion of the first conductive body of the coupled inductor and the terminal portion of the second conductive body of the coupled inductor according to one embodiment of the present invention.

FIG. 13 shows a control device for controlling the leakage inductance of a coupled inductor according to one embodiment of the present invention.

FIG. 14 shows a view of a coupled inductor according to one embodiment of the present invention.

FIG. 15 shows a view of a coupled inductor according to one embodiment of the present invention.

FIG. 16A shows that the magnetic core and the molding body of a coupled inductor are made of the same material according to one embodiment of the present invention.

FIG. 16B shows that the magnetic core and the molding body of a coupled inductor are made of the different materials according to one embodiment of the present invention.

FIG. 17A-17C shows that multiple coupled inductors are packed in a single package according to one embodiment of the present invention;

FIGS. 18A-18B shows a method to form a coupled inductor.

### DESCRIPTION OF EMBODIMENTS

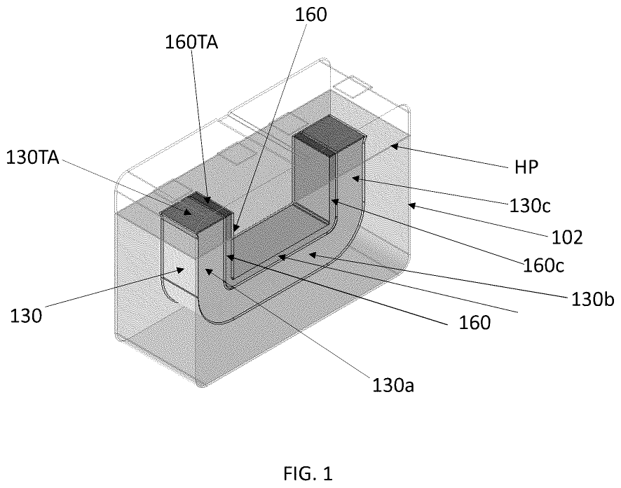

As shown in FIG. 1, the present invention discloses a coupled inductor, wherein the coupled inductor comprises: a first conductive body 130, comprising a first lateral portion 130a, a first top portion 130b, and a second lateral portion 130c, wherein the first conductive body 130 extends from the first lateral portion 130a to the second lateral portion 130c via the first top portion 130b, wherein the first conductive body 130 further comprises a first terminal portion 130d that is bent from the first lateral portion 130a and extends in a direction away from the second lateral portion 130c and a second terminal portion 130e that is bent from the second lateral portion 130c and extends in a direction away from the first lateral portion 130a; a second conductive body 160, comprising a third lateral portion 160a, a second top portion 160b, and a fourth lateral portion 160c, wherein the second conductive body 160 extends from the third lateral portion 160a to the fourth lateral portion 160c via the second top portion 160b, wherein the second conductive body 160 further comprises a third terminal portion 160d that is bent from the third lateral portion 160a and extends in a direction towards the fourth lateral portion 160c and a fourth terminal portion 160e that is bent from the fourth lateral portion 160c and extends in a direction towards the third lateral portion 160a; and a molding body 102, encapsulating the first lateral portion 130a, the first top portion 130b, and the second lateral portion 130c of the first conductive body 130.

In one embodiment, as shown in FIG. 1, on a horizontal plane HP passing through the first lateral portion 130a and the third lateral portion 160a, a cross-section surface area 130TA of the first lateral portion 130a is larger than a cross-section surface area 160TA of the third lateral portion 160a.

In one embodiment, as shown in FIG. 1, the width of the first conductive body 130 is equal to the width of the second conductive body 160.

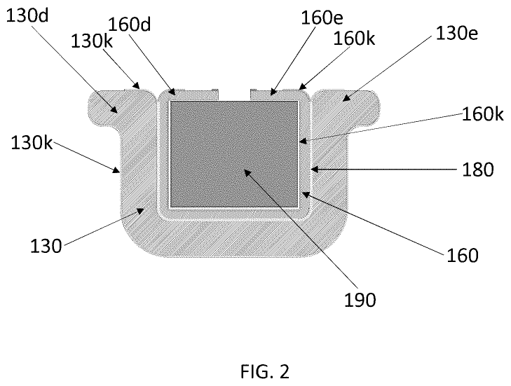

In one embodiment, as shown in FIG. 2, a magnetic core 190 is disposed in a hollow space of the second conductive body 160.

In one embodiment, as shown in FIG. 2, the molding body 102 encapsulates the first conductive body 130, the second conductive body 160 and the magnetic core 190.

In one embodiment, a material is filled in a space between the first terminal portion 130d and the third terminal portion 160d.

In one embodiment, the material is a magnetic material.

In one embodiment, the material is a polymer, an oxide or a ceramic material.

In one embodiment, the first conductive body 130 is fully encapsulated by a first insulating layer 130k, and the second conductive body 160 is fully encapsulated by a second insulating layer 160k, wherein the first insulating layer 130k is attached to the second insulating layer 160k by an adhesive material.

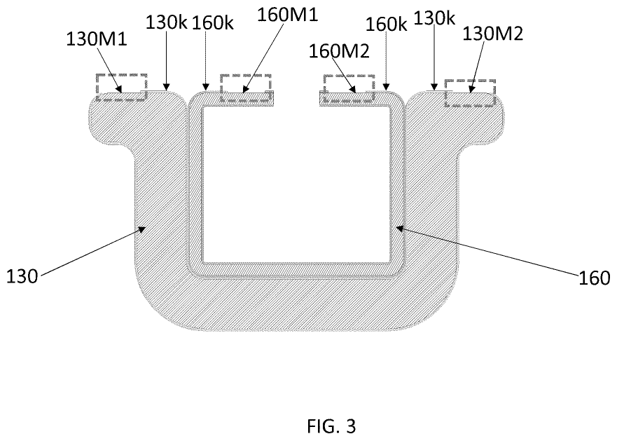

In one embodiment, as shown in FIG. 3, wherein a bottom surface of the first terminal portion is not covered by the first insulating layer 130k to expose a first inner metal portion for forming a first electrode 103M1 of the first conductive body 130.

In one embodiment, as shown in FIG. 3, a bottom surface of the second terminal portion is not covered by the first insulating layer 130k to expose a second inner metal portion for forming a second electrode 103M2 of the first conductive body 130.

In one embodiment, as shown in FIG. 3, a bottom surface of the third terminal portion 160d is not covered by the second insulating layer 160k to expose a third inner metal portion 160M1 for forming a third electrode of the second conductive body 160.

In one embodiment, as shown in FIG. 3, a bottom surface of the fourth terminal portion 160e is not covered by the second insulating layer 160k to expose a fourth inner metal portion 160M2 for forming a fourth electrode of the second conductive body 160.

In one embodiment, the curvature radius of the inner surface of the first bending portion of the first conductive body 130 is greater than or equal to the curvature radius of the outer surface of the first bending portion of the second conductive body 160.

In one embodiment, the curvature radius of the inner surface of the second bending portion of the first conductive body 130 is greater than or equal to the curvature radius of the outer surface of the second bending portion of the second conductive body 160.

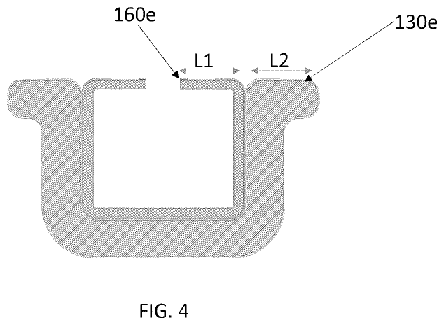

In one embodiment, as shown in FIG. 4, the length L1 of the terminal portion 160d, 160e of the second conductive body 160 is greater or equal to the length L2 of the corresponding terminal portion 130d, 130e of the first conductive body 130.

As shown in FIG. 2, The present invention discloses a coupled inductor, wherein the coupled inductor comprises: a first conductive body 130, comprising a first lateral portion 130a, a first top portion 130b, and a second lateral portion 130c, wherein the first conductive body 130 extends from the first lateral portion 130a to the second lateral portion 130c via the first top portion 130b, wherein the first conductive body 130 further comprises a first terminal portion 130d that is bent from the first lateral portion 130a and extends in a direction away from the second lateral portion 130c and a second terminal portion 130e that is bent from the second lateral portion 130c and extends in a direction away from the first lateral portion 130a; and a second conductive body 160, comprising a third lateral portion 160a, a second top portion 160b, and a fourth lateral portion 160c, wherein the second conductive body 160 extends from the third lateral portion 160a to the fourth lateral portion 160c via the second top portion 160b, wherein the second conductive body 160 further comprises a third terminal portion 160d that is bent from the third lateral portion 160a and extends in a direction towards the fourth lateral portion 160c and a fourth terminal portion 160e that is bent from the fourth lateral portion 160c and extends in a direction towards the third lateral portion 160a; wherein the first conductive body 130 is fully encapsulated by a first insulating layer 130k and the second conductive body 160 is fully encapsulated by a second insulating layer 160k, wherein the first insulating layer 130k is attached to the second insulating layer 160k by an adhesive material 180.

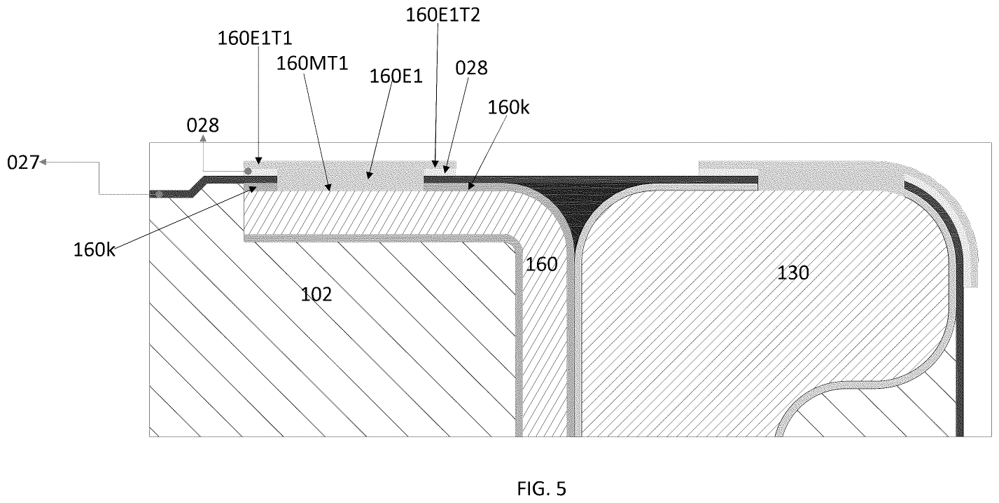

As shown in FIG. 5, the present invention discloses a coupled inductor, wherein the coupled inductor comprises: a first conductive body 130, comprising a first lateral portion 130a, a first top portion 130b, and a second lateral portion 130c, wherein the first conductive body 130 extends from the first lateral portion 130a to the second lateral portion 130c via the first top portion 130b, wherein the first conductive body 130 further comprises a first terminal portion 130d that is bent from the first lateral portion 130a and extends in a direction away from the second lateral portion 130c and a second terminal portion 130e that is bent from the second lateral portion 130c and extends in a direction away from the first lateral portion 130a; and a second conductive body 160, comprising a third lateral portion 160a, a second top portion 160b, and a fourth lateral portion 160c, wherein the second conductive body 160 extends from the third lateral portion 160a to the fourth lateral portion 160c via the second top portion 160b, wherein the second conductive body 160 further comprises a third terminal portion 160d that is bent from the third lateral portion 160a and extends in a direction towards the fourth lateral portion 160c and a fourth terminal portion 160e that is bent from the fourth lateral portion 160c and extends in a direction towards the third lateral portion 160a; wherein an electrode structure 160E1 is disposed on the inner metal portion 160M1 and electrically connected to the second conductive body 160, wherein a first top portion 160E1T1 of the electrode structure 160E1 is located on a first lateral side of the inner metal portion 160M1, wherein the first top portion of the electrode structure 160E1T1 is attached to the molding body 102 through a first silver-glue layer 028.

In one embodiment, the electrode structure 160E1 comprises three metal layers Cu, Ni, Sn with Cu layer at the bottom and Sn layer at the top.

In one embodiment, three metal layers Cu, Ni, Sn are formed by electroplating.

In one embodiment, the first top portion 160E1T1 of the electrode structure 160E1 is attached to the second insulating layer 160k of the second conductive body 160 through the first silver-glue layer 028.

In one embodiment, an insulating layer 027 is disposed between first silver-glue layer 028 and the second insulating layer 160k of the second conductive body 160.

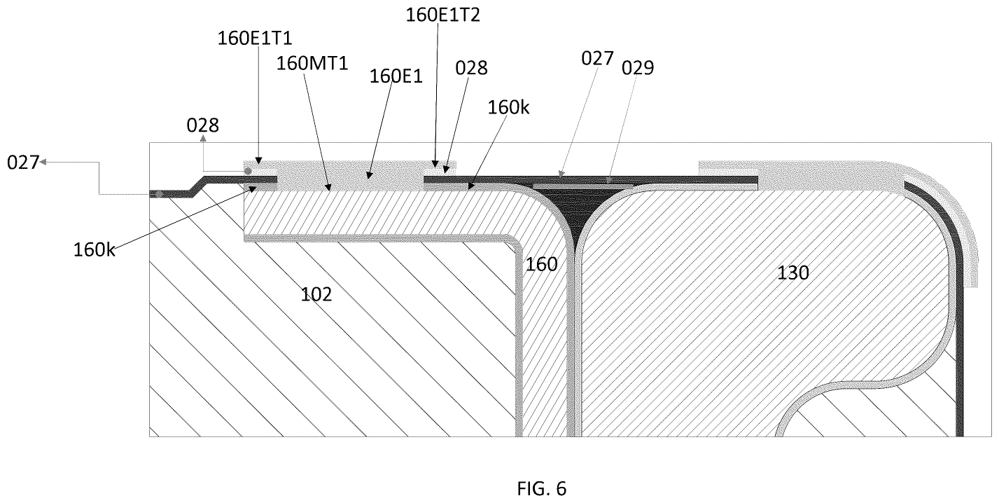

In one embodiment, the first top portion 160ET1 of the electrode structure 160E1 is attached to the second insulating layer 160k of the second conductive body 160 through a first silver-glue layer 028, wherein another insulating layer 029 is disposed under the insulating layer 027 (see FIG. 6).

In one embodiment, a second top portion 160E1T2 of the electrode structure 160E1 is located on a second lateral side of the inner metal portion 160M1, wherein the second top portion 160E1T2 of the electrode structure 160E1 is attached to the molding body 102 through the second silver-glue layer 028, wherein the first top portion 160E1T1 and second top portion 160E1T2 are on two opposite sides of the inner metal portion 160M1.

In one embodiment, the first electrode and the second electrode are respectively on the bottom of the molding body 102 and extend to the third lateral surface and the fourth lateral surface of the molding body 102, and the first electrode extends to the first lateral surface of the molding body 102 and the second lateral surface of the molding body 102.

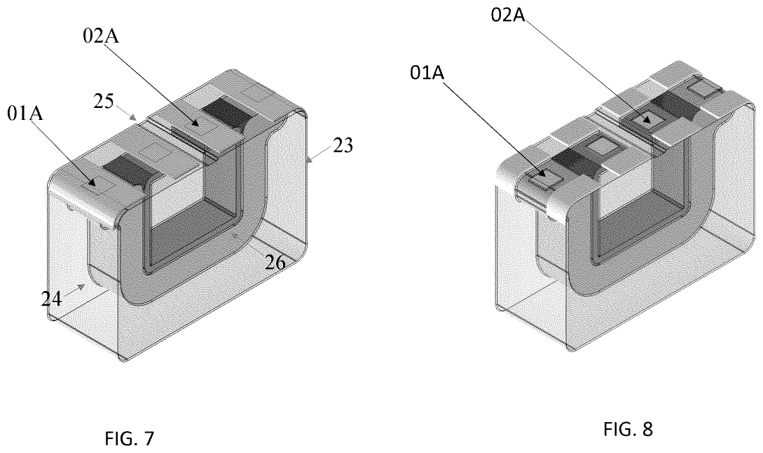

In one embodiment, as shown in FIG. 7, the first electrode is a fully extened electrode on the bottom surface of the molding body 102. The first electrode 01A and the second electrode 02A are respectively established on the bottom 021 of the package body and extend to the third side portion 025 and the fourth side portion 026 of the package body, and the first electrode 01A also extends to the first side of the package body 023 and the second side of the package body 024.

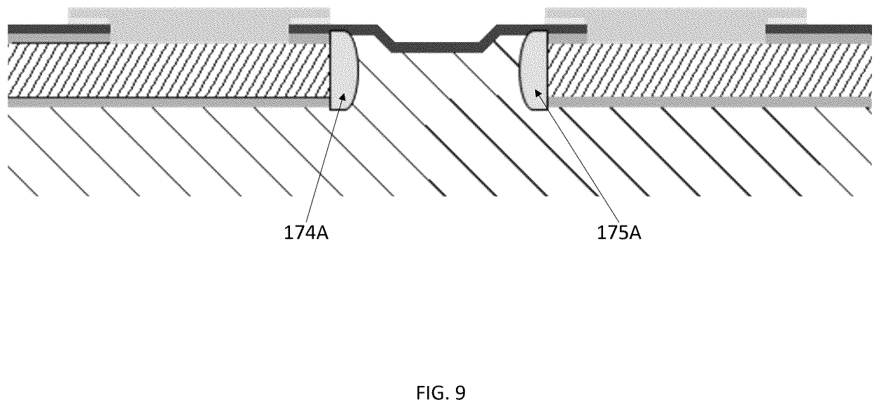

In one embodiment, as shown in FIG. 8, the first electrode is an island electrode on the bottom surface of the molding body 102 and does not extend to any lateral surface of the molding body 102.

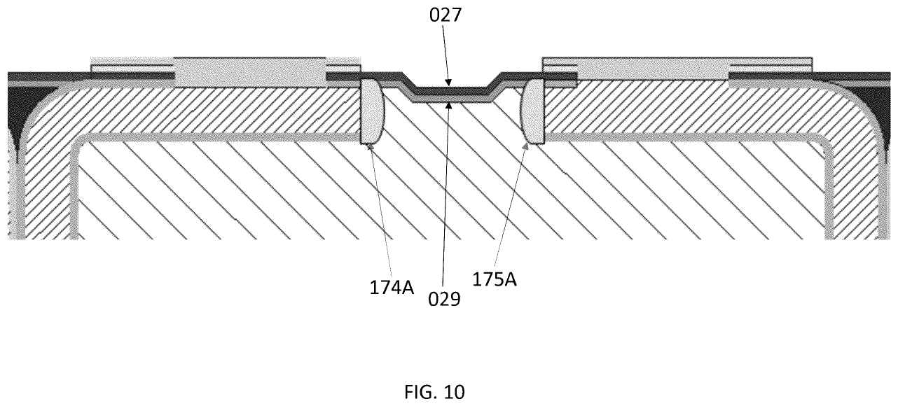

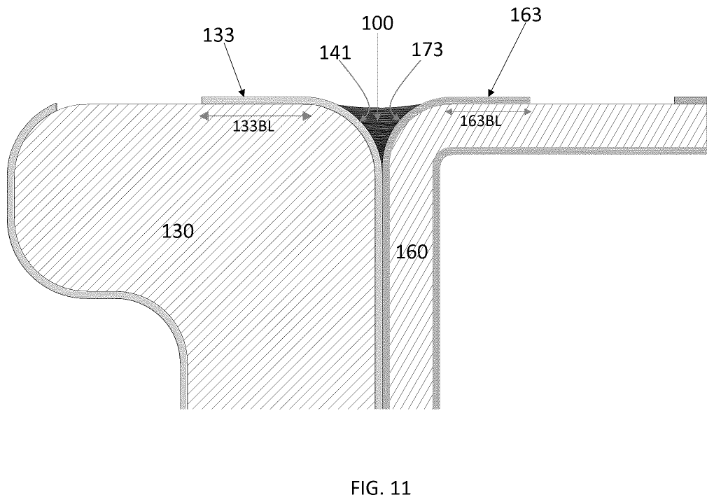

In one embodiment, as shown in FIG. 9 and FIG. 10, the first terminal side portion 174A inside the second conductive body 160 and the second terminal side portion 175A inside the second conductive body 160 are coated with an insulating material. The insulating material can be a polymer material, an oxide, a ceramic material or a magnetic material.

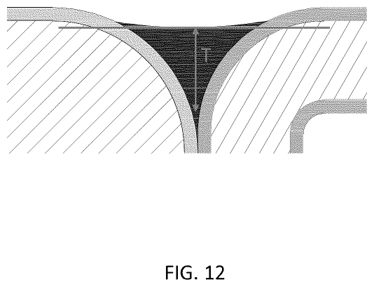

As shown in FIG. 11, the present invention discloses a coupled inductor, wherein the coupled inductor comprises: a first conductive body 130, comprising a first lateral portion 130a, a first top portion 130b, and a second lateral portion 130c, wherein the first conductive body 130 extends from the first lateral portion 130a to the second lateral portion 130c via the first top portion 130b, wherein the first conductive body 130 further comprises a first terminal portion 130d that is bent from the first lateral portion 130a and extends in a direction away from the second lateral portion 130c and a second terminal portion 130e that is bent from the second lateral portion 130c and extends in a direction away from the first lateral portion 130a; and a second conductive body 160, comprising a third lateral portion 160a, a second top portion 160b, and a fourth lateral portion 160c, wherein the second conductive body 160 extends from the third lateral portion 160a to the fourth lateral portion 160c via the second top portion 160b, wherein the second conductive body 160 further comprises a third terminal portion 160d that is bent from the third lateral portion 160a and extends in a direction towards the fourth lateral portion 160c and a fourth terminal portion 160e that is bent from the fourth lateral portion 160c and extends in a direction towards the third lateral portion 160a; wherein a material 100 is filled in a space between the first terminal portion 130d and the third terminal portion 160d.

In one embodiment, the leakage inductance or coupling coefficient can be adjusted and controlled through the size of the triangular area formed by the R angle of the second bent portion 141 inside the first conductive body 130, the R angle of the second bent portion 173 outside the second conductive body 160, and the bottom surface of the molding body 102.

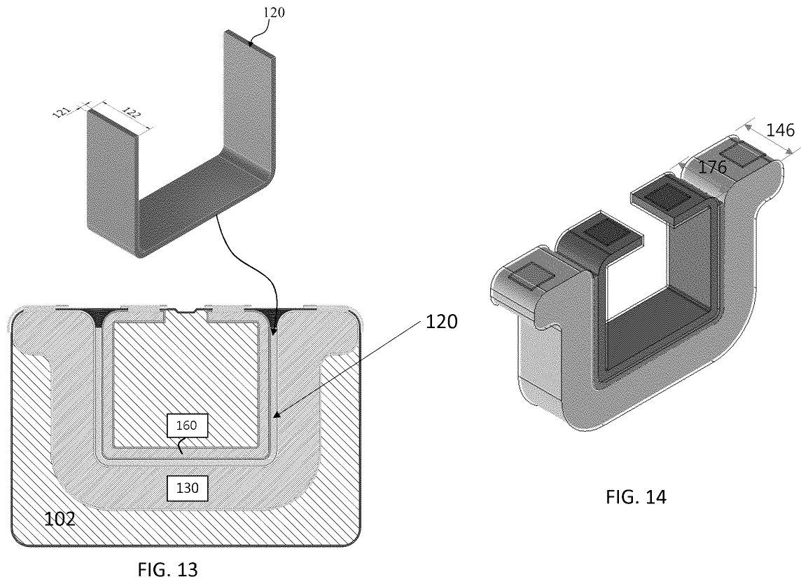

In one embodiment, as shown in FIG. 1a and FIG. 12, the filler depth T≤ the length 133BL of the bottom part 133 of the first conductive body 130 and the length 163BL of the bottom part 163 of the second conductive body 160.

In one embodiment, the material is a magnetic material.

In one embodiment, the material is a polymer, an oxide or a ceramic material.

In one embodiment, the material evenly covers and fills the triangular area formed by the second inner bending portion 141 of the first conductive body 130 and the second outer bending portion 173 of the second conductive body 160.

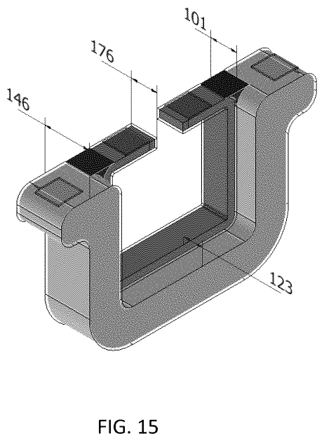

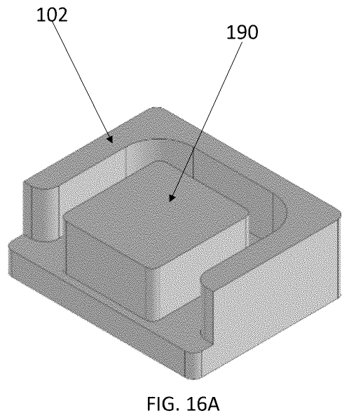

As shown in FIG. 13 and FIG. 14, a control device 120 for controlling leakage inductance is placed inside the molding body 102 as shown in the figure, where the leakage inductance control device 120 is between the first conductive body 130 and the second conductive body 160, and the leakage inductance control device width 122≤ the first conductive body line width 146 and the second conductive body line width 176. Leakage inductance or coupling coefficient between the first conductive body 130 and the second conductive body 160 are adjusted through the thickness 121 and material of the leakage inductance control device 120. The material of the leakage inductance control device (120) can be polymer materials, oxides, ceramics, magnetic materials or insulating materials.

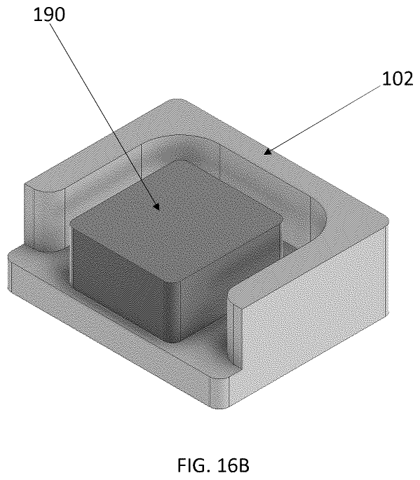

As shown in FIG. 15, the leakage inductance or coupling coefficient is finely adjusted by the size of the non-overlapping area 123 of the first conductive body 130 and the second conductive body 160, and the first conductive body line width 146> the second conductive body line width 176. The longer side length 101 of the filled material 100 is the same width as the second conductive body line width 176.

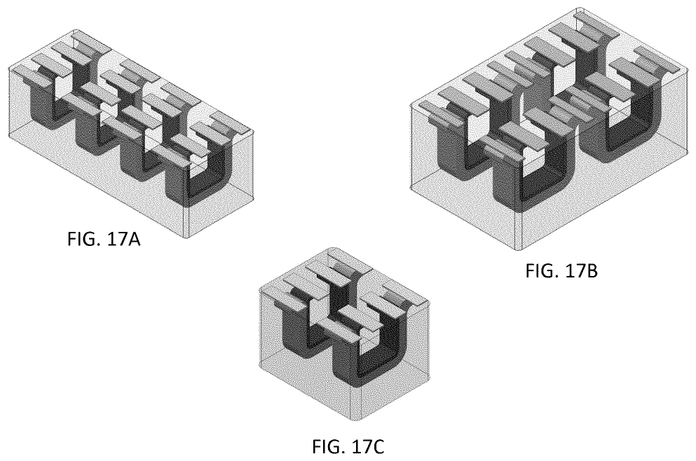

As shown in FIG. 16A, the magnetic core 190 and molding body 102 are made by the same material, wherein the material can be amorphous powder, nanocrystalline powder, carbonyl iron powder, alloy powder, Hi-Flux, Sendust, MPP or Ferrite. The composition can be C, Si, Cr, Fe, B, Co, Nb (Niobium) or Ni. It is formed by pressure molding at room temperature.

As shown in FIG. 16B, the magnetic core 190 and the molding body 102 are made by the different material. There is an insulating adhesive layer all around for assembly and adhesion of the first conductive body 130 and the second conductive body 160. The material of the magnetic core 190 can be amorphous powder, nanocrystalline powder, carbonyl iron powder, alloy powder, Hi-Flux, Sendust, MPP or Ferrite. The composition can be C, Si, Cr, Fe, B, Co, Nb (niobium) or Ni. It is usually formed by pressing the mold at normal temperature and then sintering it at high temperature. The molding body 102 can be amorphous powder, nanocrystalline powder, carbonyl iron powder, alloy powder, Hi-Flux, Sendust, MPP or Ferrite. The composition can be C, Si, Cr, Fe, B, Co, Nb (niobium) or Ni. It is formed by pressure molding at room temperature.

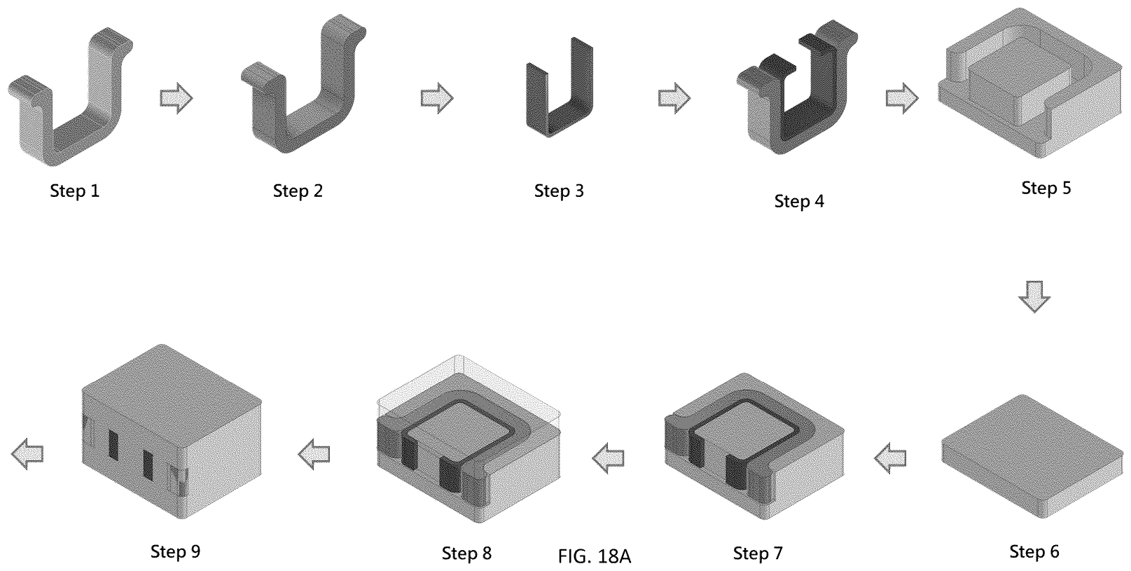

In one embodiment, as shown in FIGS. 17A-17C, multiple coupled inductors can be placed in the molding body 102.

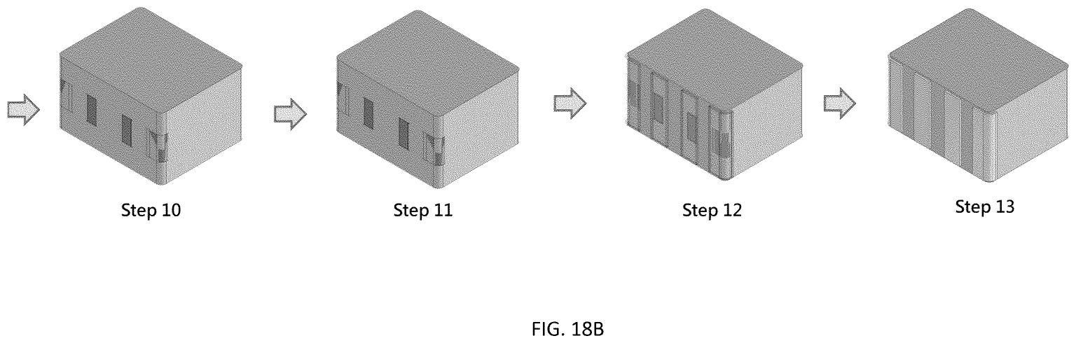

In one embodiment, as shown in FIGS. 18A-18B a method to form a coupled inductor is described as follows: Step 1: The first conductive body is formed; Step 2: an insulation layer encapsulates the first conductive body; Step 3: The second conductive body is cut & bent; Step 4: The first conductive body and the second conductive body are bonded and then assembled and bent into shape; Step 5: First positioning core molding; Step 6: Second positioning core molding; Step 7: Place the assembled coil into the first positioning core; Step 8: Assemble with the second positioning core and place it in the mold cavity; Step 9: Hot press forming; Step 10: Baking and curing or high-temperature sintering; Step 11: The product is coated with insulating glue (layer); Step 12: Laser defined electrode area Step 13: Electroplating electrodes.

From the foregoing, it will be appreciated that, although specific embodiments have been described herein for purposes of illustration, various modifications may be made without deviating from the spirit and scope of the disclosure. Furthermore, where an alternative is disclosed for a particular embodiment, this alternative may also apply to other embodiments even if not specifically stated.

What is claimed is:

1. A coupled inductor, comprising:
a first conductive body, comprising a first lateral portion, a first top portion, and a second lateral portion, wherein the first conductive body extends from the first lateral portion to the second lateral portion via the first top portion, wherein the first conductive body further comprises a first terminal portion that is bent from the first lateral portion and extends in a direction away from the second lateral portion and a second terminal portion that is bent from the second lateral portion and extends in a direction away from the first lateral portion;
a second conductive body, comprising a third lateral portion, a second top portion, and a fourth lateral portion, wherein the second conductive body extends from the third lateral portion to the fourth lateral portion via the second top portion, wherein the second conductive body further comprises a third terminal portion that is bent from the third lateral portion and extends in a direction towards the fourth lateral portion and a fourth terminal portion that is bent from the fourth lateral portion and extends in a direction towards the third lateral portion; and
a molding body, encapsulating the first lateral portion, the first top portion, and the second lateral portion of the first conductive body.

2. The coupled inductor according to claim 1, wherein a magnetic core is disposed in a hollow space of the second conductive body.

3. The coupled inductor according to claim 1, wherein the molding body encapsulates the first conductive body, the second conductive body and the magnetic core.

4. The coupled inductor according to claim 1, wherein a material is filled in a space between the first terminal portion and the third terminal portion.

5. The coupled inductor according to claim 4, wherein the material is a magnetic material.

6. The coupled inductor according to claim 4, wherein the material is a polymer, an oxide, a ceramic material or a magnetic material.

7. The coupled inductor according to claim 1, wherein the first conductive body is fully encapsulated by a first insulating layer, and the second conductive body is fully encapsulated by a second insulating layer, wherein the first insulating layer is attached to the second insulating layer by an adhesive material.

8. The coupled inductor according to claim 1, wherein a bottom surface of the first terminal portion is not covered by the first insulating layer to expose a first inner metal portion for forming a first electrode of the first conductive body.

9. The coupled inductor according to claim 8, wherein a bottom surface of the second terminal portion is not covered by the first insulating layer to expose a second inner metal portion for forming a second electrode of the first conductive body.

10. The coupled inductor according to claim 9, wherein a bottom surface of the third terminal portion is not covered by the second insulating layer to expose a third inner metal portion for forming a third electrode of the second conductive body.

11. The coupled inductor according to claim 10, wherein a bottom surface of the fourth terminal portion is not covered by the second insulating layer to expose a fourth inner metal portion for forming a fourth electrode of the second conductive body.

12. The coupled inductor according to claim 1, wherein on a horizontal plane passing through the first lateral portion and the third lateral portion, a cross-section surface area of the first lateral portion is larger than a cross-section surface area of the third lateral portion.

13. The coupled inductor according to claim 1, wherein a width of the first conductive body is equal to a width of the second conductive body.

14. The coupled inductor according to claim 1, wherein a curvature radius of an inner surface of a first bending portion of the first conductive body is greater than or equal to a curvature radius of an outer surface of a first bending portion of the second conductive body.

15. The coupled inductor according to claim 14, wherein a curvature radius of an inner surface of a second bending portion of the first conductive body is greater than or equal to a curvature radius of an outer surface of a second bending portion of the second conductive body.

16. The coupled inductor according to claim 1, wherein a length of the third terminal portion of the second conductive body is greater or equal to a length of the first terminal portion of the first conductive body.

17. A coupled inductor, comprising:
a first conductive body, comprising a first lateral portion, a first top portion, and a second lateral portion, wherein the first conductive body extends from the first lateral portion to the second lateral portion via the first top portion, wherein the first conductive body further comprises a first terminal portion that is bent from the first lateral portion and extends in a direction away from the second lateral portion; and
a second conductive body, comprising a third lateral portion, a second top portion, and a fourth lateral portion, wherein the second conductive body extends from the third lateral portion to the fourth lateral portion via the second top portion, wherein the second conductive body further comprises a second terminal portion that is bent from the third lateral portion and extends in a direction towards the fourth lateral portion;
wherein a material is filled in a space between the first terminal portion and the second terminal portion.

18. A coupled inductor, comprising:
a first conductive body, comprising a first lateral portion, a first top portion, and a second lateral portion, wherein the first conductive body extends from the first lateral portion to the second lateral portion via the first top portion, wherein the first conductive body is fully encapsulated by a first insulating layer; and
a second conductive body, comprising a third lateral portion, a second top portion, and a fourth lateral portion, wherein the second conductive body extends from the third lateral portion to the fourth lateral portion via the second top portion, wherein the second conductive body is fully encapsulated by a second insulating layer;
wherein the first insulating layer and the second insulating layer are attached by an adhesive material.

19. A coupled inductor, comprising:
a first conductive body, comprises a first terminal portion, wherein the first conductive body is encapsulated by a first insulating layer, wherein a bottom surface of the first terminal portion is not covered by the first insulating layer to expose an inner metal portion; and
a molding body, encapsulating the first conductive body, wherein an electrode structure is disposed on the inner metal portion and electrically connected to the first conductive body, wherein a first top portion of the electrode structure is located on a first lateral side of the inner metal portion, wherein the first top portion of the electrode structure is attached to the molding body through a first silver-glue layer.

20. The coupled inductor according to claim 19, wherein a second top portion of the electrode structure is located on a second lateral side of the inner metal portion, wherein the second top portion of the electrode structure is attached to the molding body through a second silver-glue layer, wherein the first top portion and the second top portion are on two opposite sides of the inner metal portion.
